(19) United States
(12) Patent Application Publication
(10) Pub. No.: US 2005/0238750 A1
(43) Pub. Date: Oct. 27, 2005

(54) Bricketting machines

(76) Inventor: Paul Rochester Brown, Ashbourne (GB)

Correspondence Address: Edward G. Greive;Renner, Kenner, Greive, Bobak, Taylor & Weber, Fourth Floor, First National Tower, Akron, OH, 44308-1456, US

(21) Appl. No.: 11/105,824

(22) Filed: Apr. 13, 2005

(30) Foreign Application Priority Data
Apr. 16, 2004 (EP) 04252243.3

(51) Int. Cl. B29C 44/02

(52) U.S. Cl. 425/345; 425/438

(57) ABSTRACT

A bricketting machine comprises a press plate (12), an intermediate plate (22) and a support plate (32) which are mounted on three pillars (14,15 and 16). A carousel generally indicated by the reference numeral (20) is rotatably mounted on bearings (26) on the pillar (16) and is provided with a number of equally spaced hardened steel dies. The carousel is mounted in means (21,26) so as to be capable of axial movement along the pillar (16) towards and away from the press plate.

### TECHNICAL FIELD

The present invention relates to a bricketting machine. Such machines are used for forming brickettes from a wide range of materials such as coal dust, wood dust, wood chip, metal chip and metal swarf.

### BACKGROUND TO THE INVENTION

Bricketting machines for compacting loose chips or swarf-like materials and metallic sludges sometimes containing oil, emulsions or water to produce a stable shaped brickette, from which the majority of the liquid is pressed out, are already known. Such machines often utilise a rotatably mounted multi-die carousel in which the ejecting means is also used to partially rotate the carousel. Such an apparatus is disclosed in GB-A-2338921 which describes a bricketting machine with an ejecting punch mounted on a swingable arm. The arm has limited angular movement to rotate the carousel exactly to its desired position. The pressing of the brickette is done in a closed die where the die is open at both ends to allow for ejection but at the pressing and filling positions, one end of the die is closed by a plate.

U.S. Pat. No. 3,847,075 discloses a turntable apparatus for a press. The turntable carries three containers and is rotatably mounted. Rotation of the turntable moves the containers between a pressing ram and an ejecting ram, such that material can be pressed and ejected. Each container comprises an continuous uniform opening, and in use, during each pressing step, the opening is sealed at its bottom end by a closing plate which is supported on an entablature. Furthermore, the turntable is enabled to move axially. In this manner, when rotational movement is required, the turntable can be moved axially to ensure the containers are clear of the closing plate. Additionally, when the containers are reengaged with the closing plate, the pressure from the main ram transfers against the entablature so that the turntable will not be subject to the working forces of the press.

It is known in other types of brickettng machine for closing of the die to be effected by an additional position entering from the opposite end of the die. This has several benefits, notably more consistent density of brickette and better removal of liquids. In the carousel design of press this has not been practical because pressing takes place in two or three positions, so the same number of additional pistons would be required which adds to the complexity and cost of the machine.

### SUMMARY OF THE INVENTION

The present invention relates to a method and apparatus based on a carousel design of press but with a more consistent density of brickette and better removal of liquids without the need for additional hydraulic cylinders for each pressing position.

In particular the present invention provides a closed die bricketting machine comprising: a plurality of dies mounted for movement from one operating station to the next; means for ejecting a brickette formed at one of the stations with the ejecting means also being operable to move the dies in a first direction between stations; at least one piston-like fixed protrusion arranged to cooperate with a die whereby to enter one end of the die; and a compressing ram arranged to cooperate with a die to enter the die at the opposite end to a corresponding piston-like fixed protrusion, whereby to compress material located in the die.

Thus, by providing a piston-like fixed protrusion which enters the die, the benefits of using two pistons, one entering each end of the die, are realised without the added complexity and cost associated with using two pistons. In particular, the kinetic energy created by the compressing piston is used efficiently and a brickette with a more even density is formed.

### BRIEF DESCRIPTION OF THE DRAWINGS

In order that the present invention be more readily understood, an embodiment thereof will now be described by way of example with reference to the accompanying drawings in which:

FIG. 1 shows an end elevation of a bricketting machine according to the present invention; and

FIG. 2 shows a cross-sectional side view of the machine shown in FIG. 1 taken along the line A-A.

### DETAILED DESCRIPTION OF PREFERRED EMBODIMENTS OF THE INVENTION

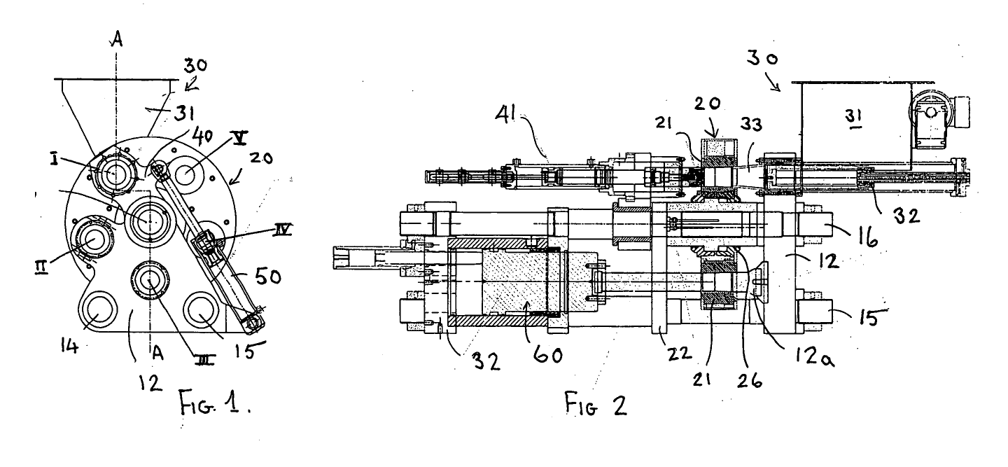

Referring to the drawings, there is shown a bricketting machine comprising a press plate 12, an intermediate plate 22 and a support plate 32 which are mounted on three pillars 14, 15 and 16. A carousel generally indicated by the reference numeral 20 is rotatably mounted on bearings 26 on the pillar 16 and is provided with a number of equally spaced, hardened steel dies. In this example, there are five dies which register with stations I-V as indicated in FIG. 1 and all dies are tapered.

A material feed mechanism 30 comprises a hopper 31 and a feed device which in this case is shown as a ram feeder 32 which is located and arranged to feed material to be compressed in the bricketting machine to a die at station I.

Also mounted on the pillar 16 is an arcuately moveable member 40 which carries a ram mechanism 41 which, in one arcuate position is in register with station V so as to eject a brickette formed by the bricketting machine and in the other arcuate position is in register with the station I so as to assist in the filling of the die at this location. Arcuate movement of the member 40 and hence the ram mechanism 41 is achieved using a piston and cylinder device 50.

A compacting ram mechanism 60 is located at each of the stations II and III and the general operation of the machine is that a die at location I is filled with material to be compacted. The carousel is then indexed so that the filled die is moved to station II where it is compacted and then indexed to station III where it is again compacted before moving to station IV where it simply remains in the die prior to being ejected at station V by the ram mechanism 41 which is moved between stations V and I under the action of the piston and cylinder device 50 which also serves to index the carousel.

In this embodiment, the carousel 20 is mounted on a special bearing 26 which not only permits rotation of the carousel about the pillar 16, but also axial movement of the carousel along the pillar 16 towards and away from the press plate 12 and between the intermediate plate 22 and the press plate 12. It is to be noted that the press plate 12 is provided with one or more fixed piston-like members 12a, are at each station, where compression is due to take place. When the carousel is indexed so that a filled die is in position at either station II or station III in this example, the carousel is moved by a suitable arrangement such as by oil being passed through drillings in the inner part of the bearing 26 towards the press plate 12 so that the fixed piston-like members 12a enter the associated die to close the end opposite to the press piston 60.

The fixed piston-like members enter the associated dies, rather than covering the ends of the dies as would be the case with the use of a closing plate. As noted above, the use of pistons rather than closing plates has several benefits, notably more consistent density of brickette and better removal of liquids. In particular, as fixed piston-like members enter the end of the die, becoming internal thereto, the kinetic energy created by the compacting ram 60 is retained in the die and used efficiently for the compression of the scrap material. This results in a brickette with a density which is maintained more evenly throughout. If a closing plate were used, the kinetic energy created by the compressing ram would not be used efficiently and the compressed material would have a lower density at the end contacting with the closing plate.

The even distribution of energy through the compressed material makes the brickettes more robust and therefore allows the size of the dies to be increased and thus the throughput capacity of the system is increased.

Furthermore, the piston-like protrusions are preferably substantially the same shape as the dies. However, preferably the piston-like protrusions do not seal the dies. This allows fluid in the scrap material to run around the profile of the fixed piston when the scrap material is compressed. This may be achieved by providing a small gap between the piston-like protrusion and the die. This gap may run round all or part of the periphery of the piston-like protrusions. The piston-like protrusion is held in tight tolerance relationship with the die. Alternatively, the piston-like protrusions may be provided with one or more channels, for the fluids to run along. This may be a single channel located toward the bottom side of the piston-like protrusion.

It should be noted that the piston-like protrusion does not cover the end of the die in the manner of a plate. Instead, the piston-like protrusion enters the material receiving section of the die.

The carousel can be moved axially either to a fixed position with respect to the press plate 12 or allowed to float during pressing which has the same effect as pressing with two pistons, one from each end but only requires one moving hydraulic ram. When pressing is complete, the press piston 60 is withdrawn from the die, the carousel is axially moved back away from the press plate 12 so that the die is clear of the fixed piston-like members 12a and then the carousel is indexed. The axial movement back away from the press plate can be achieved in any convenient fashion eg by reversing the flow of oil through the pressings and/or using return springs.

The axial movement of the carousel may be provided by direct drive from a hydraulic ram contained within the hub of the carousel itself. This enables the carousel to move freely on special bearing 26, both laterally and rotationally.

When a filled die reaches the station V, the ram mechanism 41 ejects the brickette and while the ejector is still engaged in the now empty die, the piston and cylinder device 50 is operated to rotate the carousel and the member 40 to the station I where the ram mechanism 41 remains partly in the die to stop material escaping from the die as it is filled using the material feed mechanism 30.

It is preferred that the material feed mechanism 30 includes a ram feeder with a tapered nose 33 suitable for engagement with one end of a die. The length of the nose is comparable with the length of the fixed piston-like members 12a so that as the carousel moves axially forwards or backwards towards and away from the press plate 12 during the pressing action, filling of the die at the station I can also take place.

While a carousel arrangement has been described above and implies a circular motion about a fixed centre, it will be appreciated that multiple dies could be mounted together by means other than a carousel and in fact undertake some basically linear movement between feed and compression stations.

1. A closed die bricketting machine comprising:
a plurality of dies mounted for movement from one operating station to the next;
means for ejecting a brickette formed at one of the stations with the ejecting means also being operable to move the dies in a first direction between stations;
at least one piston-like fixed protrusion arranged to cooperate with a die whereby to enter one end of the die;
and
a compressing ram arranged to cooperate with a die to enter the die at the opposite end to a corresponding piston-like fixed protrusion, whereby to compress material located in the die.

2. A machine according to claim 1 in which the dies are mounted in means capable of moving in a direction transverse to the first direction between stations.

3. A machine according to claim 1 in which said plurality of dies are mounted in a carousel which is mounted for rotation on a column.

4. A machine according to claim 3 in which said ejecting means is operable to rotate said carousel around said column.

5. A machine according to claim 4 in which said ejecting means comprises:
a ram mechanism; and
moving means arranged to move said ram whereby to move said dies in a first direction between stations.

6. A machine according to claim 5 in which said moving means comprises a arcuately moveable member and a piston and cylinder device.

7. A machine according to claim 3 in which the transverse direction is axially along said column.

8. A machine according to claim 7 wherein said carousel is mounted on a bearing which allows axial movement of the carousel.

9. A machine according to claim 8 wherein said axial movement is achieved by passing oil through the inner part of the bearing.

10. A machine according to claim 8 wherein said bearing includes a return spring.

11. A machine according to claim 8 wherein said axial movement is provided by a hydraulic ram provided in the hub of the carousel.

12. A machine according to claim 3 wherein said dies are equally spaced around said carousel.

13. A machine according to claim 3 wherein said dies are tapered.

14. A machine according to claim 13 wherein said dies are narrower at the ends into which said piston-like protrusions are arranged to enter.

15. A machine according to claim 1 further comprising a press plate.

16. A machine according to claim 15, wherein said press plate comprises said at least one piston-like fixed protrusion.

17. A machine according to claim 1 wherein feed means are provided which comprises a ram feeder with tapered nose arranged to be engaged in one die.

18. A machine according to claim 17 wherein said feed means further comprises a hopper.
